(19) United States
(12) Patent Application Publication
(10) Pub. No.: US 2024/0426384 A1
(43) Pub. Date: Dec. 26, 2024

(54) MULTI-PORT VALVE WITH PROPORTIONAL FLOW FUNCTION

(71) Applicant: JOHNSON ELECTRIC INTERNATIONAL AG, Murten (CH)

(72) Inventors: Alessandro Florian BOSSI, Cordast (CH); Nicolas DI VIA, Granges-Paccot (CH); Emmanuel VUICHARD, Epagny (CH)

(21) Appl. No.: 18/828,259

(22) Filed: Sep. 9, 2024

Related U.S. Application Data
(63) Continuation of application No. PCT/EP2022/055681, filed on Mar. 7, 2022.

(51) Int. Cl. F16K 11/085

(52) U.S. Cl. CPC F16K 11/085

(57) ABSTRACT

The invention relates to a multi-port valve comprising a valve housing having an axial port and a plurality of circumferential ports, and a valve member having at least two flow channels therethrough. The valve member is movable within the valve housing about an axis to alter a fluid flow through the multi-port valve by changing the position of the at least two flow channels. At least one proportional flow condition is achievable between the plurality of circumferential ports. There is also a sealing arrangement positioned between the valve housing and the valve member, the valve member being movable relative to the sealing arrangement. The sealing arrangement comprises a seal associated with each of the plurality of circumferential ports. In one embodiment of the invention, the seal associated with the third circumferential port and the seal associated with the fourth circumferential port are provided on a single sealing element.

### CROSS REFERENCE TO RELATED APPLICATIONS

This non-provisional patent application is continuation application of PCT Application No. PCT/EP2022/055681, filed with the European Patent Office on Mar. 7, 2022, which is incorporated herein by reference in their entirety.

### FIELD OF THE INVENTION

The present invention relates to a multi-port valve, particularly but not necessarily exclusively for use in coolant circuits for motor vehicles. The invention further relates to a coolant system for a motor vehicle, in particular, for an electric vehicle.

### BACKGROUND

Proportional regulation of coolant flow within an engine of a motor vehicle is typically controlled by a three-way valve. Coolant is proportionally directed from the main coolant circuit between the battery/electrical drive unit loop and the radiator. A further valve is then provided which allows for crossing functionality. This is usually a four-way valve which allows diversion of incoming flow to the various components requiring cooling, for instance, between the battery and the electrical drive unit, and will typically have one inlet from the proportional regulation valve, and another from another system within the circuit.

This arrangement requires multiple actuators to operate the different valves, creating significant amounts of infrastructure, as additional connecting pipework or tubing is required, and pressure drops in the system result in a bulkier set-up and a higher overall cost.

There is an additional issue associated with proportional regulation of the coolant flow, in that, when the valve member is in a transitionary state, the back-pressure at the inlets of the valve can result in a fluid hammer effect as pressure builds up behind the inlet whilst the port to the valve is blocked. For quieter vehicles, particularly electric vehicles, water hammer can create a surprising and distracting noise for the driver, and therefore minimising the noise created by the fluid hammer effect is desirable.

### SUMMARY OF THE INVENTION

It is an object of the present invention to provide a multi-port valve which is able to overcome or obviate the above-referenced issues.

According to a first aspect of the invention, there is provided a multi-port valve comprising: a valve housing having an axial port and a plurality of circumferential ports; a valve member having at least two flow channels therethrough, the valve member being movable within the valve housing about an axis to alter a fluid flow through the multi-port valve by changing the position of the at least two flow channels, wherein at least one dedicated proportional flow condition is achievable between the plurality of circumferential ports; and a sealing arrangement positioned between the valve housing and the valve member, the valve member being movable relative to the sealing arrangement, the sealing arrangement comprising a seal associated with each of the plurality of circumferential ports; characterised in that the seal associated with the third circumferential port and the seal associated with the fourth circumferential port are provided on a single sealing element.

The present invention is a multi-port valve which is designed to firstly reduce number of actuators used in a vehicular coolant system, by providing a valve arrangement which is capable of both proportional and crossing flow functionality. The use of surge-prevention openings, either as part of the sealing arrangement or as part of the valve member itself, provides a means of obviating issues associated with fluid hammer effects. The surge-prevention openings provide leak pathways from pressurised ports through to the axial port in particular during transitional rotational positions of the valve. As such, the noise generated by fluid hammer effects is drastically reduced, and the valve becomes more appropriate to use in quiet vehicles, such as electric vehicles. The term dedicated proportional flow condition is intended to refer to a valve position in which proportional flow is desirable, and therefore is an intended use condition of the valve. It will be appreciated that valves in the art may, due to inadequate sealing arrangements or intermediate transitionary valve positions, create unintentional pseudo-proportional flow conditions. This is not the intention of the present invention.

In one desirable embodiment, the plurality of circumferential ports may be located in a single plane.

For many automotive applications, the axial dimension of an actuator is more difficult to accommodate within the confines around the existing coolant circuit. As such, a low-profile actuator is most helpful within a coolant system context.

Optionally, the valve member may comprise first and second said flow channels, a circumferential dimension of an inter-channel wall of a body of the valve member which is between the two flow channels being less than a circumferential dimension of a seal aperture of the at least one oversized seal.

The relationship between the walls of the body of the valve member and the oversizing of the seal of at least one port is one means of effectively creating a surge-prevention opening. This results in non-sealing conditions being formed during transitional rotation of the valve member, allowing fluid overflow into the axial port, and thereby sufficiently reducing back pressure to mitigate the effects of fluid hammer noise during transition. Since the transition times are short, this pressure loss has minimal effect on the operational capacity of the system.

Preferably, the first flow channel may extend from a first circumferential opening to a second circumferential opening of the valve member.

This flow channel structure, which tends towards a chord line of the valve member when viewed from above, provides a pathway through the valve member which can lead to proportional behaviour, if the accompanying port arrangement is correct.

The plurality of circumferential ports may comprises two outlet circumferential ports which may be circumferentially spaced apart by a distance which is less than a circumferential dimension of at least one of the first and second circumferential openings of the first said flow channel.

Proximate circumferential ports relative to the dimensioning of the circumferential openings of the fluid channels is a means of enabling proportional flow behaviour. If the circumferential opening of the valve member is greater than the distance between the circumferential ports, flow can be split proportionally.

Optionally, the second flow channel may extend from a third circumferential opening to an axial opening of the valve member.

The radial-type of flow channel combines well with the chord-line type flow channel, as the flows therethrough are effectively perpendicular to one another, which provides for lots of potential different crossing and proportional behaviours to be integrated.

The third circumferential opening may have a circumferential dimension which is equal to or substantially equal to the circumferential dimension of the at least one oversized seal.

If the third circumferential opening has a dimension matching the oversized seal or seals, then there will be limited opportunity for unexpected leak paths to develop in true proportional or crossing valve positions.

Optionally, the plurality of circumferential ports may comprise a first circumferential port, a second circumferential port, a third circumferential port, and a fourth circumferential port.

At least four circumferential ports would be expected to be necessary in order to produce desirable proportional and crossing behaviour.

Preferably, the seal associated with the first circumferential port may be a said oversized seal.

The oversized seal allows for leak paths around the valve member to be created, and by having at least one port having such a seal, reduces the effect of fluid hammer noise from that said port.

Additionally, or alternatively, the seal associated with the second circumferential port may be a said oversized seal.

It is preferred that a plurality of ports have the surge-prevention capability provided by the seal, as this allows for a substantially symmetric valve to be produced, which is important for the creation of multiple different proportional flow conditions.

In one embodiment, the seal associated with the third circumferential port and the seal associated with the fourth circumferential port may be provided on a single sealing element.

Combining the seals of proximate ports together will simplify the installation process of the sealing arrangement into the valve housing.

The said sealing element may comprise a cover panel intermediate the seals. The sealing element comprises at least one lip and at least one wing, wherein the at least one lip is provided for improving the internal leakage between circumferential ports and at least one wing is provided for reducing the torque required for driving the multi-port valve.

Here, reducing the valve internal leakage can improve the overall energy heat loss at vehicle level thus improving overall vehicle efficiency in terms of cost and performance. Further, reducing the valve torque in turns lowering the electrical current drawn by the valve actuator thus less energy consumption at vehicle system level, which is beneficial for reducing operational costs and improving overall vehicle efficiency.

The presence of such a cover panel prevents undesirable flow crossing between the third and fourth circumferential ports, ensuring that expected proportional flow behaviour is maintained.

A shape of the said sealing element may optionally be a superposition of two overlapping oblong or obround shapes, wherein the cover panel is dimensioned to an overlap region thereof.

The superposition shaping of the sealing element ensures that there is no prospect of the cross-leaking between the third and fourth circumferential ports.

Preferably, there may be at least one proportional flow condition from the first circumferential port to the third and fourth circumferential ports, and at least one proportional flow condition from the second circumferential port to the third and fourth circumferential ports.

The ability to provide proportional flow behaviour from different inlet ports allows for the crossing functionality to be combined with proportional flow behaviour when two coolant circuits are combined together, which is usual when cooling both a radiator of a motor vehicle, as well as the battery/electrical drive unit.

The multi-port valve may also have at least one further proportional flow condition.

The shaping of the valve member can lead to alternative proportionality conditions, particularly between the first and second circumferential ports, which may significantly increase the utility of the valve.

At least one seal may be provided as a protruding rim relative to a surface of an associated sealing element.

The provision of a protruding rim or lip on the sealing elements advantageously provides a sealing effect with the valve member, without inhibiting the rotation movement thereof.

According to a second aspect of the invention, there is provided a coolant system for a motor vehicle, the coolant system comprising at least one multi-port valve in accordance with the first aspect of the invention.

The need for proportional and crossing behaviour is keenly felt in the coolant circuit arrangement of motor vehicles, and as such, the present invention is highly suited towards integration into such a system.

Preferably, the motor vehicle may be an electric vehicle.

Electric vehicles are noticeably quiet, and therefore the effect of fluid hammer noise in the coolant system is far more noticeable. The present invention has been designed with this problem in mind.

### BRIEF DESCRIPTION OF THE DRAWINGS

The invention will now be more particularly described, by way of example only, with reference to the accompanying drawings, in which:

FIG. 1 shows a front perspective view of a valve member suitable for use in one embodiment of a multi-port valve in accordance with the first aspect of the invention;

FIG. 2 shows a horizontal cross-section through the multi-port valve having the valve member of FIG. 1;

FIG. 3 shows a diagrammatic representation of the sealing arrangement of the multi-port valve of FIG. 2;

FIG. 4 shows a first dedicated proportional flow condition of the multi-port valve of FIG. 2;

FIG. 5 shows a second dedicated proportional flow condition of the multi-port valve of FIG. 2;

FIG. 6 shows a first outlet-blocked condition of the multi-port valve of FIG. 2;

FIG. 7 shows a first outlet-blocked condition of the multi-port valve of FIG. 2;

FIG. 8 shows a third dedicated proportional flow condition of the multi-port valve of FIG. 2; and

FIG. 9 shows a transitionary surge-prevention condition of the multi-port valve of FIG. 2.

### DETAILED DESCRIPTION OF THE PREFERRED EMBODIMENTS

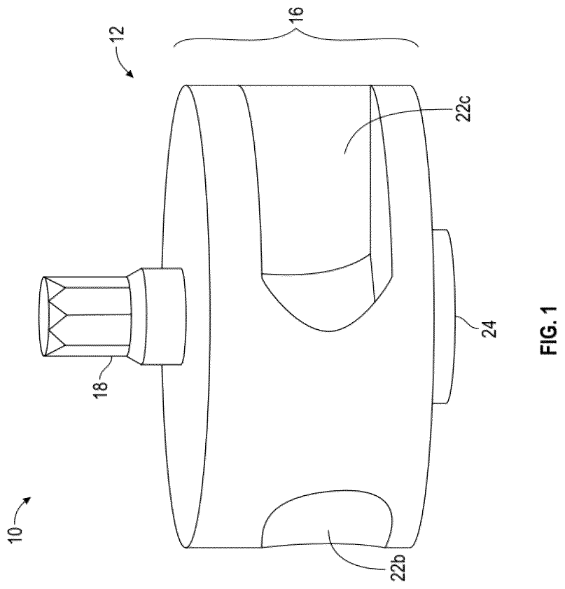

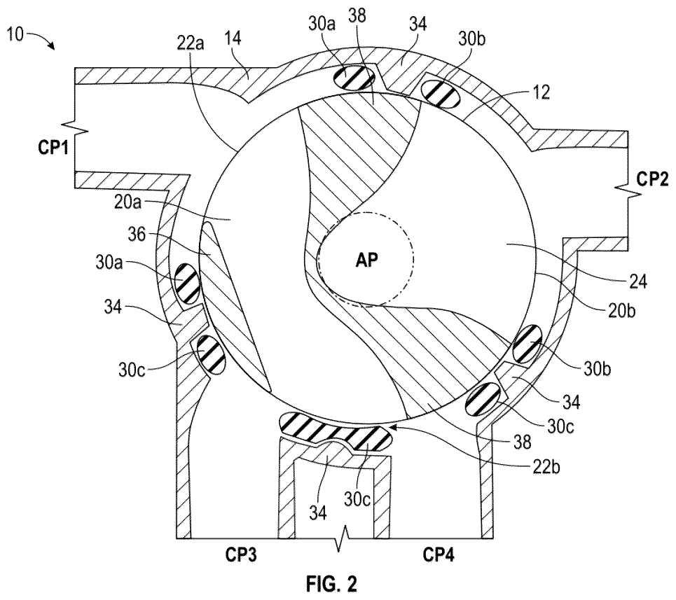

Referring firstly to FIG. 1, there is shown part of a multi-part valve, referenced globally at 10, indicated as a valve member 12 outside of its corresponding valve housing 14, which can be seen in the cross-section shown in FIG. 2.

The valve member 12 has a body 16 which is cylindrical, being drivable via an actuator through its shaft 18. The shaft 18 may have a key or similar non-circular engagement portion for rotationally locking to a drive output of the associated actuator.

The body 16 has a first flow channel 20a therethrough, best seen in FIG. 2, which extends between a first circumferential opening 22a and a second circumferential opening 22b, with the first flow channel 20a extending within or substantially within a horizontal plane of the body 16. There is a second flow channel 20b, which extends between a third circumferential opening 22c and an axial opening 24 which opens out through a base of the body 16. The second flow channel 20b thus directs flow in a substantially perpendicular direction to the first flow channel 20a. Both of the first and second flow channels 20a, 20b are, however, bounded between their respective openings 22a, 22b, 22c, 24.

The valve housing 14 is a five-port housing, having four circumferential ports CP1, CP2, CP3, CP4, and one axial port AP. The axial port AP is in constant communication with the axial opening 24 of the valve member 12, but the relative positions of the circumferential ports CP1, CP2, CP3, CP4 with respect to the circumferential openings 22a, 22b, 22c dictates the behaviour of the valve. In a majority of intended use scenarios, the first and second circumferential ports CP1, CP2 will primarily function as inlet ports, whilst the third and fourth circumferential ports CP3, CP4 will primarily function as outlet ports. Modification of the valve member 12 position can, of course, alter the functionality of the valve 10.

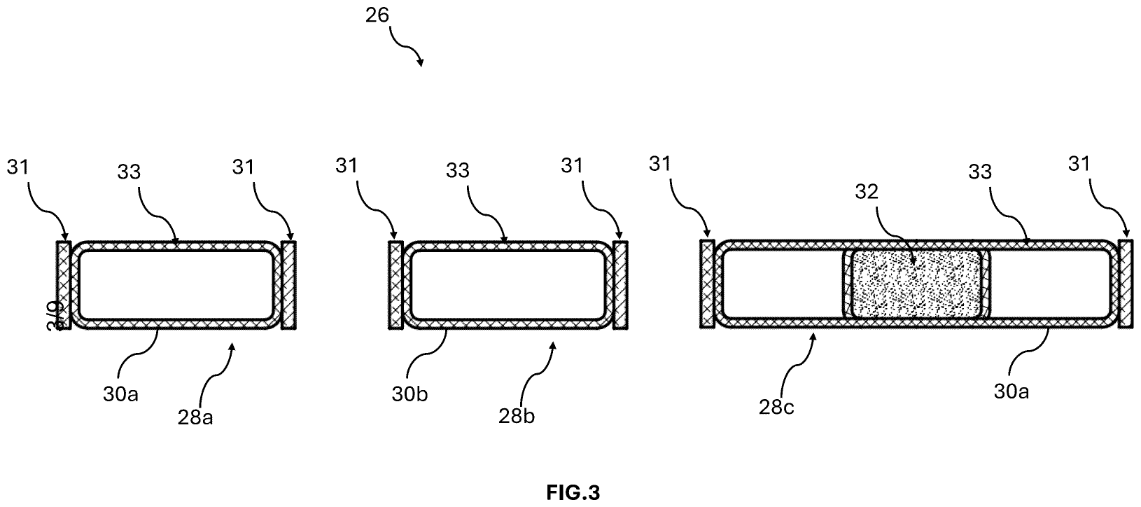

There is a sealing arrangement 26 between the valve housing 14 and the valve member 12, and the sealing elements 28a, 28b, 28c of the sealing arrangement 26 are illustrated in FIG. 3. The first and second sealing elements 28a, 28b respectively provide sealing between the first circumferential port CP1 and the valve member 12, and the second circumferential port CP2 and the valve member 12. Each of the first and second sealing elements 28a, 28b creates a seal 30a, 30b, which is here an oversized seal with respect to the corresponding first and second circumferential ports CP1, CP2. The sealing elements 28a, 28b, 28c are formed from a resilient material. In preferred embodiments, the resilient material is a Ethylene Propylene Diene Monomer (EPDM) material.

The third sealing element 28c provides sealing for both of the third and fourth circumferential ports CP3, CP4 with respect to the valve member 12, though it will be appreciated that separate seals could be provided associated with each of the third and fourth circumferential ports CP3, CP4 instead. However, the third sealing element 28c includes two seals 30c which are separated by a cover panel 32, providing a sealing effect to eliminate leak paths between the third and fourth circumferential ports CP3, CP4. The cover panel 32 has a surface from which the seals 30c can be deemed to protrude from, and in this scenario, the seals 32c are thus formed as a protruding rim or lip 33 relative to the said surface. Indeed, any or all of the seals 30a, 30b, 30c may be formed as a protruding rim 33 from a surface of the corresponding sealing element 28a, 28b, 28c. The lip (33) is provided for improving the internal leakage between circumferential ports (CP3) and (CP4). The wing (31) is provided for reducing the torque required for driving the multi-port valve (10).

The sealing arrangement 26 may be held in place within the valve housing 14 by the provision of one or more locators 34, here illustrated as ribs or inward projections into the internal chamber of the valve housing where the valve member 12 is located.

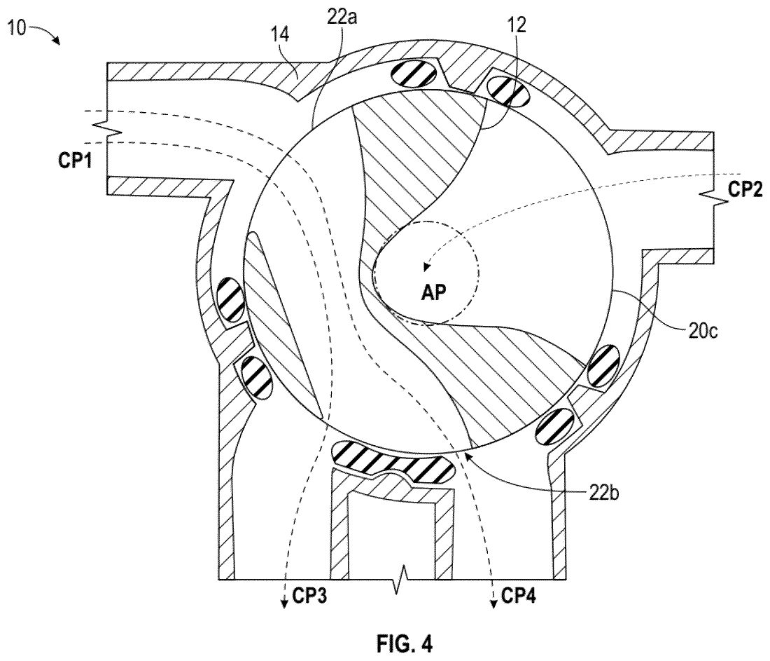

The multi-port valve 10 is able to combine the crossing function and proportional function which are currently provided in engine coolant systems using a single valve, and thus, a single actuator. Various examples of useful valve positions are illustrated in FIGS. 4 to 10, with the dashed arrows indicating fluid flow direction.

In a typical arrangement, the first circumferential port CP1 would be connected to an inlet from a first coolant loop, and therefore would generally act as an inlet port. The second circumferential port CP2 would also generally act as an inlet port, usually being an inlet from a second coolant loop, perhaps to another valve on the circuit. The third circumferential port CP3 might be a radiator outlet, with the fourth circumferential port CP4 being directed to the first loop which is directed to the battery/electrical drive unit part of the circuit. Proportional flow between the third and fourth circumferential ports CP3, CP4 is therefore desirable. The axial port AP would typically be an outlet to the said second coolant loop. As such, it is expected that pressure build-up would occur during transitional valve member positions primarily at the first and second circumferential ports CP1, CP2.

FIG. 4 illustrates a first dedicated proportional flow condition. The first flow channel 20a has its first circumferential opening 22a aligned to the first circumferential port CP1, whilst the second circumferential opening 22b is positioned to direct flow to both of the third and fourth circumferential ports CP3, CP4 in a ratio proportional to the relative area of overlap. For this to work, the circumferential dimension of the second circumferential opening 22b must be greater than a circumferential dimension intermediate the third and fourth circumferential ports CP3, CP4; without this, proportional flow cannot be achieved.

Simultaneously, the third circumferential opening 20c of the second flow channel 20b is aligned to the second circumferential port CP2, thereby directing flow from the second circumferential port CP2 to the axial port AP.

Rotation of the valve member 12 by a few degrees in either direction will alter the proportionality of flow between the third and fourth circumferential ports CP3, CP4, according to the user's needs.

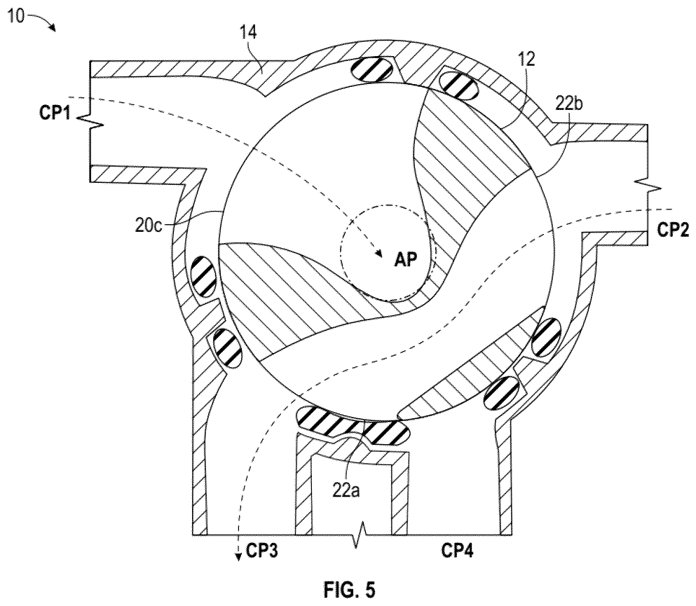

FIG. 5 shows the reverse dedicated proportional condition. The second flow channel 20b interconnects the first circumferential port CP1 with the axial port AP, whilst proportional flow is achieved from the second circumferential port CP2 to the third and fourth circumferential ports CP3, CP4, via the first flow channel 20a. The first circumferential opening 22a of the first flow channel 20a now aligns to the third and fourth circumferential ports CP3, CP4, whereas the second circumferential opening 22b aligns to the second circumferential port CP2. For this reason, it is preferred that the first and second circumferential openings 22a, 22b be otherwise identically dimensioned, so as to not create any unusual flow properties and thus differences between the dedicated proportional flow conditions illustrated in FIGS. 4 and 5 respectively.

Proportional flow in either of these scenarios is achieved by the relative positioning of the bounded first flow channel relative to the third and fourth circumferential ports CP3, CP4. This is a result of careful relative dimensioning of the valve member 12 and the valve housing 14.

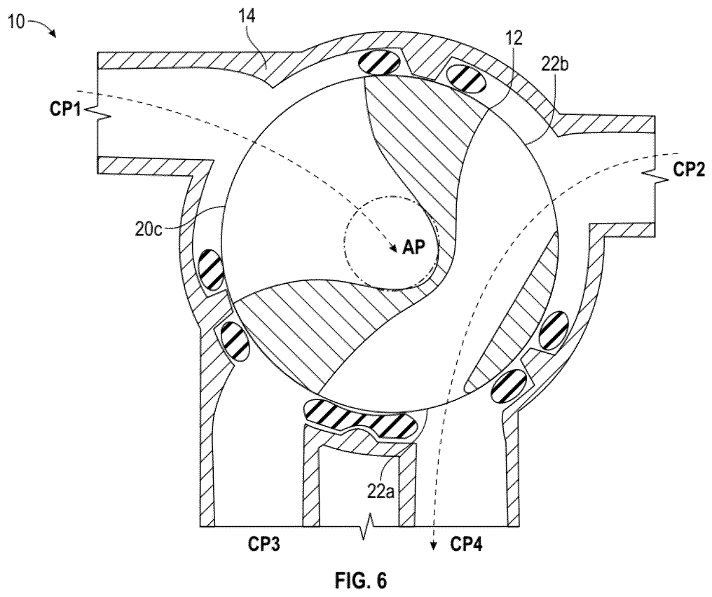

Proportional flow can be stopped by blocking one or other of the third and fourth circumferential ports CP3, CP4. FIG. 6 shows the position of the valve member 12 in which an inter-channel wall 36 of the body 16 intermediate the first and second flow channels 20a, 20b blocks the third circumferential port CP3, since this inter-channel wall 36 is larger, in a circumferential dimension, than the corresponding seal 30c. Flow from the second circumferential port CP2 runs directly to the fourth circumferential port CP4, and there is no cross-leakage from the first circumferential port CP1.

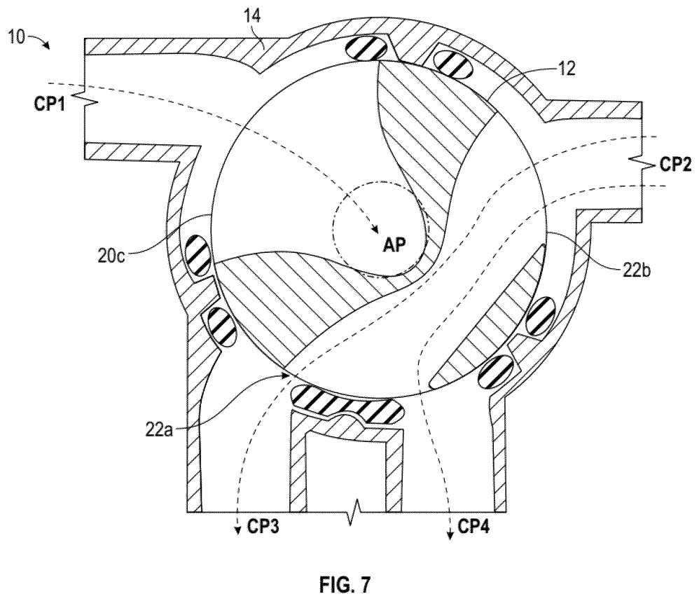

FIG. 7 shows the reverse condition, in which a channel side-wall 38 of the body 16 which is adjacent to the first flow channel 20a only blocks the fourth circumferential port CP4. Again, this channel side-wall 38 is larger, in a circumferential dimension, than the corresponding seal 30c. Flow from the second circumferential port CP2 runs directly to the third circumferential port CP3, and there is no cross-leakage from the first circumferential port CP1.

Of course, alternative dedicated proportional flow conditions can be considered, depending upon the configuration of the system into which the multi-port valve 10 is installed.

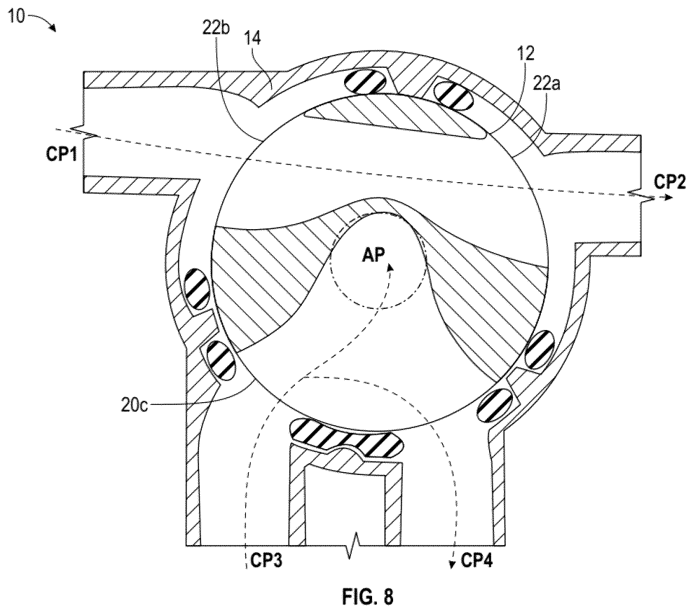

One such example is indicated in FIG. 8, in which the first flow channel 20a interconnects the first and second circumferential ports CP1, CP2. In this instance, the pressure behind the first circumferential port exceeds that behind the second circumferential port CP2, and therefore flow proceeds from the first circumferential port CP1 to the second circumferential port CP2. This will, of course, depend on the system configuration. Proportional flow can then occur from the third circumferential port CP3 between the fourth circumferential port CP4 and the axial port AP.

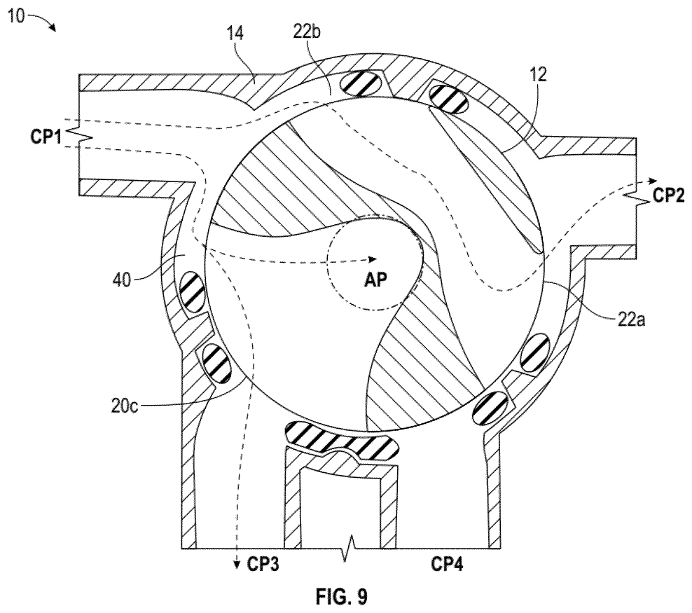

One of the advantages of the present arrangement is that the effects of pressure surge are mitigated, avoiding the potential for fluid hammer effects within the coolant system, and this is illustrated in FIG. 9. Here, one of the inter-channel walls 36 is in a position which would usually block the first circumferential port CP1, causing a fluid hammer effect and generating noise. However, the sealing arrangement 26 is configured such that the seal 30a of the first sealing element 28a is oversized relative to the first circumferential port CP1. This means that the seal 30a leaks around the inter-channel wall 36. The oversizing of the seal 30a thus effectively creates a surge-prevention opening 40 to circumvent the valve body 16.

This leakage causes no deleterious effects, since the valve member 12 does not remain in this transitionary position for a long duration, since there are no useful flow paths created for the coolant system. Fluid is able to flow from the first circumferential port CP1 temporarily into the second circumferential port CP2, the third circumferential port CP3, and the axial port AP.

The seal 30b of the second sealing element 28b is configured for the second circumferential port CP2 as the seal 30a of the first sealing element 28a is for the circumferential port CP1.

The embodiment shown in FIGS. 1 to 9 represents an axially-compact five-port valve 10, in which there are four co-planar circumferential reports CP1, CP2, CP3, CP4 and one axial port AP. The sealing arrangement 26, being held in place relative to the valve member 12 by the valve housing 14. Both proportional behaviour, as well as crossing functionality between different coolant loops is provided, whilst only requiring a single actuator to control the valve member 12. This represents a significant improvement over valves known in the art.

It is noted that in none of the embodiments shown is there any need for an axial seal. The fluid pressure pushes the valve member towards the actuator direction, avoiding any additional sealing requirement.

It is therefore possible to provide a multi-port valve which is capable of providing both proportional flow control, particularly but not necessarily exclusively for the coolant system of an electric vehicle, as well as crossing functionality between different loops of the said system. The multi-port valve is highly suited towards use in electric vehicles, as it has the capability of preventing or significantly reducing fluid hammer effects within the coolant system, which are loud and undesirable in vehicles having quieter engines or motors. The combination of the proportionality and crossing functions also reduce the cost and complexity of the valve control arrangement, as the valve can be operated via a single drive actuator.

The words ‘comprises/comprising’ and the words ‘having/including’ when used herein with reference to the present invention are used to specify the presence of stated features, integers, steps, or components, but do not preclude the presence or addition of one or more other features, integers, steps, components, or groups thereof.

It is appreciated that certain features of the invention, which are, for clarity, described in the context of separate embodiments, may also be provided in combination in a single embodiment. Conversely, various features of the invention which are, for brevity, described in the context of a single embodiment, may also be provided separately or in any suitable sub-combination.

The embodiments described above are provided by way of examples only, and various other modifications will be apparent to persons skilled in the field without departing from the scope of the invention as defined herein.

1. A multi-port valve comprising:
a valve housing having an axial port and a plurality of circumferential ports;
a valve member having at least two flow channels therethrough, the valve member being movable within the valve housing about an axis to alter a fluid flow through the multi-port valve by changing the position of the at least two flow channels, wherein at least one dedicated proportional flow condition is achievable between the plurality of circumferential ports; and
a sealing arrangement positioned between the valve housing and the valve member, the valve member being movable relative to the sealing arrangement, the sealing arrangement comprising a seal associated with each of the plurality of circumferential ports;
characterised in that the seal associated with the third circumferential port and the seal associated with the fourth circumferential port are provided on a single sealing element.

2. The multi-port valve of claim 1, wherein the single sealing element comprises at least one lip and at least one wing.

3. The multi-port valve of claim 2, wherein the at least one lip is provided for improving the internal leakage between circumferential ports.

4. The multi-port valve of claim 2, wherein at least one wing is provided for reducing the torque required for driving the multi-port valve.

5. The multi-port valve of claim 1, wherein the at least one seal of the sealing arrangement is oversized relative to the corresponding circumferential port to provide a surge-prevention pathway around the valve member to the axial port.

6. A multi-port valve as claimed in claim 1, wherein the plurality of circumferential ports is located in a single plane.

7. A multi-port valve as claimed in claim 1, wherein the valve member comprises first and second said flow channels, a circumferential dimension of an inter-channel wall of a body of the valve member which is between the two flow channels being less than a circumferential dimension of a seal aperture of the at least one oversized seal.

8. A multi-port valve as claimed in claim 7, wherein the first flow channel extends from a first circumferential opening to a second circumferential opening of the valve member.

9. A multi-port valve as claimed in claim 1, wherein the plurality of circumferential ports comprises two outlet circumferential ports which are circumferentially spaced apart by a distance which is less than a circumferential dimension of at least one of the first and second circumferential openings of the first said flow channel.

10. A multi-port valve as claimed in claim 7, wherein the second flow channel extends from a third circumferential opening to an axial opening of the valve member.

11. A multi-port valve as claimed in claim 10, wherein the third circumferential opening has a circumferential dimension which is equal to or substantially equal to the circumferential dimension of the at least one oversized seal.

12. A multi-port valve as claimed in claim 1, wherein the plurality of circumferential ports comprises a first circumferential port, a second circumferential port, a third circumferential port, and a fourth circumferential port.

13. A multi-port valve as claimed in claim 1, wherein the said sealing element comprises a cover panel intermediate the seals.

14. A multi-port valve as claimed in claim 1, wherein a shape of the said sealing element is a superposition of two overlapping oblong or obround shapes, wherein the cover panel is dimensioned to an overlap region thereof.

15. A multi-port valve as claimed in any one of claim 12, wherein there is at least one proportional flow condition from the first circumferential port to the third and fourth circumferential ports, and at least one proportional flow condition from the second circumferential port to the third and fourth circumferential ports.

16. A multi-port valve as claimed in claim 15, wherein there is at least one further proportional flow condition.

17. A multi-port valve as claimed in claim 5, wherein at least one seal is provided as a protruding rim relative to a surface of an associated sealing element.

18. A multi-port valve as claimed in claim 1, wherein the valve member being movable within the valve housing to provide crossing function and proportional function.

19. A coolant system for a motor vehicle, the coolant system comprising at least one multi-port valve as claimed in claim 1.
